(19) United States
(12) Patent Application Publication
(10) Pub. No.: US 2011/0147197 A1
(43) Pub. Date: Jun. 23, 2011

(54) METHODS FOR ENHANCING ADSORPTION OF MOLECULES

(76) Inventor: Jian Xie, Carmel, IN (US)

(21) Appl. No.: 12/996,867

(22) PCT Filed: Jun. 11, 2009
(86) PCT No.: PCT/US09/46973

§ 371 Date: Mar. 14, 2011

Related U.S. Application Data
(60) Provisional application No. 61/060,634, filed on Jun. 11, 2008.

(51) Int. Cl. B01J 37/34; B01J 19/08

(52) U.S. Cl. 204/155; 422/186.04

(57) ABSTRACT

Provided are methods for enhancing adsorption of molecules, and particularly essentially non-polar molecules, such as hydrogen and hydrocarbons, as well as methods of storing and releasing such molecules from an adsorbent. Also provided are storage units for the storage and release of such molecules.

With the pressing environmental requirements on reducing automobile emissions, finding an alternative automotive propulsion system with fewer emissions than an internal combustion engine has become more urgent than ever. Recently, rising oil prices have accelerated the demand for this effort/exploration—not only for emissions, but also for higher energy efficiency and the use of energy from alternative sources. Polymer Electrolyte Fuel Cells (PEFCs) are a candidate for automobile propulsion due to their ultimate environmental cleanliness—zero emissions, low operating temperatures (e.g., 80° C.), high energy efficiency (for example, >65%) and the use of alternative fuels such as hydrogen (Gasteiger et al., “Activity benchmarks and requirements for Pt, Pt-alloy, and non-Pt oxygen reduction catalysts for PEMFCs”, Applied Catalysis B: Environmental, 56, 9-35 (2005)).

Both the automobile industry and federal agencies (for example, the Department of Energy (DOE)) have heavily invested on PEFC research and development. The DOE alone has spent $900 million for fuel cell research and development during the fiscal years from 2004 to 2008 (Milliken, “Overview of the DOE Hydrogen Program”, DOE Hydrogen Program Manager, Fuel Cell Pre-Solicitation Workshop, Washington, Jan. 23-24, 2008). It is estimated GM has spent an average of $300 million per year since 1998 on PEFC research and development. One of the major Japanese automobile manufacturers, Toyota, has spent two to three times that amount on funding PEFC research and development. As a result, in January of 2008, GM launched the largest fuel cell vehicle fleet in the world: more than 100 Chevrolet Equinox vehicles (see http://www.gm.com/corporate/investor_information/docs/fin_dataigm06ar/content/feature/technology5.html).

A fuel cell vehicle requires an on-board hydrogen supply either through fuel reforming or hydrogen storage. The on-board hydrogen supply remains one of the major technical barriers for fuel cell vehicle commercialization. Before 2004, the original technical approach for the hydrogen supply on a fuel cell vehicle used on-board hydrocarbon (gasoline or diesel) fuel reforming. The on-board fuel reformer is a complicated system and requires quite a bit of fuel, operating at high temperatures (for example, 600-800° C.). This significantly reduces the efficiency of fuel reformer-type fuel cell propulsion systems. In addition, the time it takes for the cold-start of the fuel reformer is far too long (about 30 minutes) to meet the vehicle requirements due to the slow warm-up of the fuel reformer (for example, from −40° C. to 700° C.). Both the DOE and the automobile industry sponsored extensive technology development of on-board fuel reforming for many years. After comprehensive system analysis and technology evaluation of performance, energy efficiency, cost and reliability of on-board fuel reforming, both the DOE and the automobile industry abandoned the on-board fuel reforming approach.

Recent efforts have focused on the on-board hydrogen storage approach. Therefore, on-board hydrogen storage is necessary to the success of the commercialization of polymer electrolyte fuel cells (PEFCs) for both automotive applications and off-board uses such as stationary power generation. In recent years, the DOE has significantly increased its budget for hydrogen storage research and development from $13.6 million in the FY 2004 (vs. $24.5 million on fuel cell research and development) to $59.2 million in FY 2009 (vs. $62.7 million) (Milliken, supra).

The ideal hydrogen storage technology should meet two criteria: (1) to store as much hydrogen as possible, and (2) to use as little energy as possible for storing and releasing hydrogen (for example, less than 5% of the total energy). There are different types of hydrogen storage technologies under development: (1) absorption based, using metal hydrides; (2) adsorption based, using carbon adsorbents; (3) chemical reaction based, using the reaction of alkali metal with water; (4) pressure based; and (5) liquid hydrogen based (Sakintuna et al., “Metal hydride materials for solid hydrogen storage: A review”, International Journal of Hydrogen Energy, 32, 1121-1140 (2007); Liu et al., “Hydrogen Storage in Single-Walled Carbon Nanotubes at Room Temperature”, Science, 286, 1127-1129 (1999); Kojima et al., “Compressed hydrogen generation using chemical hydride”, Journal of Power Sources, 135, 36-41 (2004); Takeichi et al., ““Hybrid hydrogen storage vessel, a novel high-pressure hydrogen storage vessel combined with hydrogen storage material”, International Journal of Hydrogen Energy, 28, 1121-1129, (2003); Khurana et al., “Thermal stratification in ribbed liquid hydrogen storage tanks”, International Journal of Hydrogen Energy, 31, 2299-2309 (2006)).

The current absorption based technology using reversible metal hydrides have low hydrogen capacities and slow kinetics (e.g., sodium alanate doped with Ti has less than 4 wt. % hydrogen storage). The chemical reaction of alkali metal with water to store hydrogen could reach a high hydrogen storage capacity (for example, 10 wt. % for NaBH₄), but the reaction is nonreversible, and the dehydrogenation is fast. The nonreversibility is unacceptable for vehicle applications.

The liquid hydrogen method uses a lot of energy to change hydrogen from gas into liquid form, and to maintain its liquid state thereafter. High pressure hydrogen storage presents a safety hazard due to its extremely high pressure (Petrovic et al., “Hydrogen Storage for Vehicular Fuel Cell Applications”, MST-DO Seminar, Los Alamos National Laboratory, Apr. 15, 2003).

None of the above technologies have reached the DOE hydrogen storage target of 0.06 by 2010, and 0.09 by 2015 (kg hydrogen/kg). Developing a reversible, safe, and less energy-consuming technology for storing hydrogen is the primary challenge for fuel cell vehicle commercialization.

Gas physical adsorption over a solid adsorbent is a reversible, safe, and less energy-consuming process that can be used to store hydrogen gas. The essential of gas physical adsorption is the attraction between a gas molecule and a solid adsorbent surface. The attraction occurs through a van der Waals force, which is a long range weak force. Van der Waals force is made up of a Keesom force (i.e., electrostatic interactions between charges, dipoles, and quadruples), induction, and a London force (International Union of Pure and Applied Chemistry (1994). “van der Waals forces”. Compendium of Chemical Terminology, Internet edition; Dzyaloshinskii et al., “General theory of van der Waals' forces”, Soviet Physics Uspekhi, 4, 153-176 (1961); Autumn et al., “Evidence for van der Waals adhesion in gecko setae”. Proceedings of the National Academy of Sciences of the US, 99, 12252-12256 (2002); Douglas et al., “Concepts and Models of Inorganic Chemistry” 3^{rd} ed, p 99, John Wiley &Sons, Inc. 1994).

To store hydrogen using gas physical adsorption, hydrogen gas molecules need to be adsorbed over the adsorbent surface effectively. However, this is not the case at room temperature because the diatomic hydrogen molecule has no permanent dipole due to its symmetrical molecular orbit. An electric dipole is a separation of positive and negative charge (Brau, Modern Problems in Classical Electrodynamics. Oxford University Press. (2004); Griffiths, Introduction to Electrodynamics, 3rd ed., Prentice Hall. (1999)). As the hydrogen molecule orbit is symmetrical, the negative electronic charges distribute uniformly. The positive charge center of protons is perfectly overlapped with the negative charge center of the electrons. This makes the dipole of the hydrogen molecule zero as long as there is no external interruption and the pair of electrons stays at their lowest energy states. The distribution of electronic charge is spherically symmetrical on a time average, resulting in a zero dipole (there is momentarily an asymmetrical electronic charge distribution, generating an instantaneous dipole (Douglas et al., supra)). Such a small dipole results in a very weak London force, consequently, a very weak attraction between hydrogen molecules and adsorbent surface. This is the reason that hydrogen molecule adsorption over a solid surface can only occur at very low temperature (77° K), at which temperature the thermal energy is smaller than the van der Waals force, allowing the hydrogen molecules to adsorb on the solid surface (Wagg et al.,” Experimental Gibbs Energy Considerations in the Nucleation and Growth of Single-Walled Carbon Nanotubes”, J. Phys. B, 109, 10435-10440 (2005)). Even at such very low temperatures, hydrogen adsorption is very limited due to the weak van der Waals forces.

### DESCRIPTION OF THE DRAWINGS

FIG. 1. Schematic of experimental apparatus

FIG. 2. Hydrogen adsorption under electric field at room temperature

FIG. 3. Hydrogen adsorption under electric field at room temperature

FIG. 4. Hydrogen adsorption under electric field at room temperature

FIG. 5. Hydrogen adsorption under electric field at room temperature

Provided are methods for enhancing the adsorption properties of molecules, preferably essentially non-polar molecules, including hydrogen and other essentially non-polar hydrogen containing molecules, and mixtures thereof, as well as methods of storing and releasing such molecules on and from, respectively, an adsorbent. Also provided are storage units for the storage and release of such molecules.

New hydrogen storage technology is described, which is reversible, safe and efficient. Desirably, the adsorbent can store at least about 0.06 kg hydrogen/kg, when hydrogen is employed. Further, the temperature at which this capacity can be realized is ambient or room temperature (15-30° C.).

The invention encompasses the use of this approach to molecules in general which are susceptible, and/or in which there is a desire, to increase their dipole to increase adsorption. Understandably, essentially non-polar molecules are desired targets, and are those molecules which are considered non-polar or nearly so, exhibiting a small or zero dipole, and whose adsorption can be increased by exposure to an electric/magnetic field. Such molecules include hydrogen and essentially non-polar hydrogen containing molecules, such as hydrocarbons which includes alkanes and aromatic hydrocarbons. Examples include methane, ethane, propane, butane, and benzene. Preferably, the molecules are in the gas state.

The electric/magnetic field employed is sufficient to increase the dipole of the molecules in order to enhance adsorption of the molecules on the adsorbent. Desirably, the field will be sufficient to result in the adsorbent having at least about 0.06, more desirably at least about 0.14, and most desireably at least about 0.30 kg/kg adsorbent, particularly when hydrogen is employed.

In the following, while the use of hydrogen is discussed, the applicability to other molecules, and particularly essentially non-polar molecules, is to be understood.

Altering the van der Waals force is necessary to improve hydrogen adsorption. If the hydrogen molecule dipole can be increased significantly, the interaction/bonding energy between the hydrogen molecule and the adsorbent solid surface will be greatly enhanced since the attraction is electric in nature In order to accomplish this, the hydrogen molecule is polarized by using a magnetic/electric field. Under such strong electric field, the distribution of electronic charge around the protons in a hydrogen molecule is changed, resulting in an asymmetric distribution of electronic charge. This causes the separation of positive charge and negative charge in the hydrogen molecules. The hydrogen molecule electrons will be raised upward to a slightly higher energy level than their ground state. The polarized hydrogen molecules under such a field will have a stronger dipole, resulting in the stronger interaction/bonding energy between the polarized hydrogen molecules and the adsorbent surface.

In order to further enhance this interaction, a high surface area adsorbent with either positive or negative charge is used to attract the polarized hydrogen molecule. Once the polarized hydrogen molecule adsorbs on the charged surface, the strong magnetic/electric field can be removed while keeping the surface charged by applying electric potentials. After removing the strong field, the adsorbed hydrogen molecules still maintain their strong dipoles induced by the surface charges. Thus, hydrogen storage is accomplished.

Release of hydrogen can be achieved by reducing surface charges, which will weaken the interaction between the adsorbed hydrogen molecules and the adsorbent surface. This causes hydrogen molecules to leave the adsorbent surface. In this way, the hydrogen can be released in a controlled manner. Quantum mechanic calculation shows that a 0.0069427 Debeye dipole can be created under 0.002au (1.0284e9 V/m or 3.4304e4 statV/cm) electric field (Kobus et al., “Comparison of the polarizabilities and hyperpolarizabilities obtained from finite basis set and finite difference Hartree-Fock calculations for diatomic molecules”, J. Phys. B: At. Mol. Opt. Phys. 34, 5127 (2001)). If the high surface area carbon aerogel (3000 m²/g) is used as the adsorbent and the polarized hydrogen molecules forms a mono adsorption layer over the adsorbent surface, the theoretical hydrogen adsorption is 30.28 wt. % or 23.24 wt. % (for 2000 m²/g carbon surface area). This is far more than the DOE target for the year 2015, 9 wt. % (Petrovic et al., supra).

An object of the invention is to provide novel technology for effectively storing hydrogen. The proposed technology will achieve the much higher hydrogen storage (20-30 wt. % vs. 9 wt. % DOE target at year of 2015 (Petrovic et al., supra). The previous research and development efforts on hydrogen storage using physical adsorption were focused on the adsorbent materials, including such efforts as modifying the surface by doping different elements to the adsorbent to form charge centers, decorating carbon surface with alkali metals, using materials with different surface features (i.e., carbon nanotube (Wagg et al., supra), developing nanoparticles of Titanium-Carbide, and functionalizing porous carbons. Unfortunately, these approaches have not shown significant progress, owing to the absence of permanent dipole in hydrogen molecules, resulting in extremely low hydrogen physical adsorption. The invention focuses on the hydrogen gas molecules' ability to adsorb.

Experiments are conducted to establish the utility of using high electric/magnetic field to induce a dipole in a hydrogen molecule. The initial quantum mechanic modeling shows that such a dipole can be generated. The experimental results directly and quantitatively demonstrate whether hydrogen can be stored using this approach. This approach describes a novel technology for storing hydrogen in an effective, safe and reversible way.

Investigation of the effect of the induced dipole and the surface charge on the magnitude of the attraction between hydrogen molecule and adsorbent surface is set forth. As stated previously, a method to use physical adsorption to store hydrogen is to enhance the attraction between the hydrogen molecules and the adsorbent surface. Inducing a dipole in a hydrogen molecule is the first step. The polarized hydrogen molecules need to align with the surface charge in a way that the polarized hydrogen molecules will not be repelled by the surface charge to drift away from the surface. This requires control of the surface charge and the electric/magnetic field. After the hydrogen molecules adsorbed on the adsorbent surface, surface charge is needed to maintain the induced dipoles. Therefore, the effect of the surface charge and the electric/magnetic field on the attraction has to be optimized for maximizing the hydrogen storage. Quantum mechanic modeling is used to estimate the conditions to guide the experimental work.

A novel hydrogen storage technology which can reach high storage capacity and low energy consumption is described, using physical adsorption. To enhance the hydrogen physical adsorption over a solid adsorbent surface, a high electric/magnetic field is applied over the hydrogen molecules to induce a strong dipole. Charges are created on the adsorbent surface by applying certain potentials to the adsorbent. In this way, the attraction between hydrogen molecules and the adsorbent surface is enhanced through the interaction of hydrogen molecule dipole and adsorbent surface charges. Consequently, this results in increased hydrogen adsorption over the adsorbent surface since the attraction is electric in nature.

The steps used are: (1) building an experimental apparatus capable of applying high electric/magnetic field with tunable field strength over hydrogen gas; (2) selecting the adsorbent materials; (3) executing experiments to prove the proposed idea; and, (4) investigating the effects of the electric/magnetic field on the hydrogen adsorption to achieve the maximum hydrogen storage.

An experimental apparatus is fabricated for this hydrogen storage research. Apparatus capable of supplying a tunable electric/magnetic field is commercially available. Based on the initial quantum calculations, a 3.4304e4 statV/cm electric field is needed for 6.9427×10⁻³Debeye dipole in a hydrogen molecule (Kobus et al., supra). The container, or storage unit, for holding the hydrogen gas and adsorbents can be designed with less than 0.1 cm thickness. Therefore, the needed electric field, 3.4304e4 statV/cm, can be achieved using a 10 kV DC voltage supply, which is capable of generating 10.0e8 stat V/cm if a 0.1 cm thick container is used. Commercial hydrogen gas analyzers are available. Quantum mechanics modeling are also conducted.

After the completion of the experimental apparatus, the adsorbent materials are selected based on their surface areas and chemical/physical properties. Then, preliminary experimental work is carried out to prove the proposed concept. In addition to the experimental work, quantum mechanics modeling is used to help determine the experimental conditions, such as surface charge and electric/magnetic field. Following is the detailed description of these tasks.

The preferred design is to use porous conductive solid (e.g., carbon black, (carbon blacks with >3200 m²/g made using zerolite precursor or made using metal organic framework), carbon nanotube, doped carbon nanotube or carbon aerogel) with high surface area as the adsorbent. The adsorbent can be in powder form, thin film or the like, and is placed into a nonmetallic container with electric connection to a potentiostat/power supply. The use of nonmetallic material is to avoid any spark induced under high electric/magnetic field. The adsorbent is arranged inside the container in such a way that the adsorbent can have maximum surface area for hydrogen access, while still providing good electric connection to permit adjustment of the charge on the adsorbent. The hydrogen is introduced into the container under pressure. Then a very strong magnetic field is applied to the container while a potential is applied to the adsorbent to create charges on its surface. Hydrogen molecules are polarized under the strong electric/magnetic field and a dipole is generated within the hydrogen molecule. The induced dipole is attracted by the charged adsorbents. Thus, the polarized hydrogen gas molecules are adsorbed onto the adsorbent surface and hydrogen is stored. The removal of the electric/magnetic field should not substantially decrease the interaction between dipole and charge since the dipole is sustained by the charges. The release of the adsorbed hydrogen molecules is achieved by adjusting the potential applied to the adsorbent. With reduced potential, the amount of charge on the adsorbent is reduced, weakening the interaction/bonding energy of hydrogen dipole and charge, freeing the hydrogen molecule from the adsorbent surface. Thus, the hydrogen can be released in a controlled manner.

The apparatus includes (1) a container which holds both the adsorbent and the hydrogen gas, (2) a cooling device to control the temperature of the container, (3) a unit for measuring hydrogen volume or mass, (4) a high voltage/magnetic field supply, and (5) a potentiostat to control the potentials of the adsorbents. The container is constructed from non-conductive and non-magnetic materials (e.g., glass or polymers) to avoid interference with the applied electric/magnetic field. The container also should be capable of withstanding the strong electric/magnetic field. The container needs to be sealed to avoid any leakage of hydrogen gas.

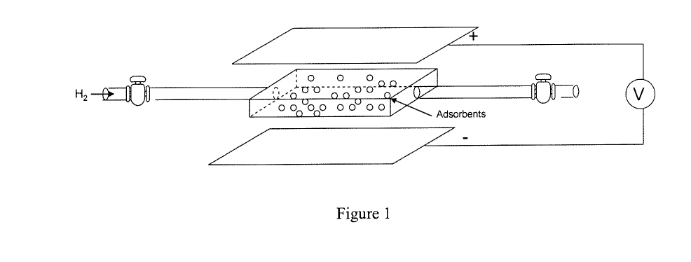

An illustrative geometry of the container is a flat rectangular glass bottle with a thickness of less than 0.1 cm, such as shown in FIG. 1. The less the thickness of the container, the higher the electric field strength can be, consequently, the higher the dipoles of the hydrogen molecules. The potential of the adsorbent surface is controlled using a potentiostat.

For hydrogen storage research, the amount of hydrogen gas adsorbed over an adsorbent surface must be accurately measured. This generally requires the measurement of either the volume or the mass of adsorbed hydrogen gas. A hydrogen gas analyzer based on the volumetric hydrogen adsorption may be used to measure the amount of the adsorbed hydrogen gas. More specifically, the hydrogen isothermal adsorption curves are measured using SETARAM PCTPro-2000 Sieverts-type gas sorption analyzer, and the amount of hydrogen is calculated. The hydrogen physical adsorption also needs to be measured under different temperatures to determine the amount of adsorbed hydrogen gas. Suitable hydrogen gas analyzers are commercially available. The cooling device can use a liquid nitrogen dewar, a glass vessel containing liquid nitrogen inside.

Materials used as adsorbents desirably need to be chemical stable under strong electric/magnetic field. They also desirably need to have high electronic conductivity and high purity to avoid inducing any decomposition under the strong electric/magnetic field. High surface area is critical for physical adsorption. Based on these requirements, the primary materials are carbon aerogel (3000 m²/g), carbon blacks, and functionalized carbon blacks, which are commercially available.

Argon gas first flows through the small container which is full of carbon aerogel as adsorbents for a period of time (e.g., 20 minutes) to ensure that all air is removed. Then, hydrogen gas is introduced into the container at a very low flow rate. The volume of hydrogen gas is measured at both the inlet and outlet to monitor the difference between the hydrogen at the inlet and outlet. Once the difference reaches zero, there is no Ar in the container. A high electric field (10×e7 statV/cm) is applied on the container when the hydrogen completely fills the container. The pressure at different temperatures is measured and an isothermal curve is obtained. Once the difference of hydrogen volume at inlet and outlet reaches zero, the adsorption is complete. Then, the valve is closed and the system is purged with argon to remove any residual hydrogen gas. The electric field is removed and the valve is opened. The adsorbed hydrogen gas is released and its volume is measured by the hydrogen gas analyzer. The first hydrogen adsorption under a high electric field will be experimented for the carbon aerogel without any potential as the baseline. Then, experiments on various surface charges of carbon aerogel adsorbents are studied to determine the effect of the surface charge on hydrogen adsorption.

In order to create and control the charges on the adsorbent surface, a reliable and accurate measurement of surface charge is needed. This measurement can be carried out using the zero charge potential (ZCP), which is the potential of the surface when the charge on the surface is zero. The ZCP of carbon aerogel can be determined using a potentiostat by measuring a series of differential capacitances of the double layer at different potentials. The surface charge can also be determined using the cyclic voltammetry through the integration of a measured cyclic voltamagram. Therefore, a relationship of surface charge and potential of adsorbent is established. The AC impedance also can be used to measure the ZCP. The ZCP of carbon aeorgel under hydrogen atmosphere at different electric/magnetic fields will be measured and will serve as the base for adjusting surface charges.

A small amount of high surface carbon aerogel is used as the adsorbent. This carbon aerogel powder is placed on a small piece of graphite plate connected with the potentiostat. The carbon aerogel powder along with the graphite plates is placed into the small flat glass vessel with thickness less then 0.1 cm. As described previously, a certain amount of hydrogen is introduced into this container, and then a high electric/magnetic field is applied to the container to induce the hydrogen dipole. The potential of the carbon aerogel is set at a value to create certain amount of the surface charges according to the established potential-charge curve. Then, the container is flushed using argon. The potential of the adsorbent surface is set to be the ZPC to release the adsorbed hydrogen gas. The released hydrogen gas is measured using the hydrogen gas analyzer. This experiment is repeated at different temperatures to determine the conditions of maximum hydrogen storage.

For safety concern, the amount of hydrogen in an experiment needs to be minimized as well as the applied magnetic/electric field. Consideration should be given to the accuracy of the hydrogen measurement because the accuracy is proportional to the amount of hydrogen to some extent. Quantum mechanics modeling is used to estimate the basic parameters for the project. The following parameters are calculated:

(1) The volume or mass of needed hydrogen for accurate measurement (unit measurement accuracy);

(2) The magnitude of electric/magnetic field for inducing dipoles of hydrogen molecules (quantum mechanics modeling);

(3) The surface charge needed for hydrogen molecule adsorption (quantum mechanics modeling);

(4) The needed van der Waals force to overcome the thermal energy at different temperatures (quantum mechanics modeling).

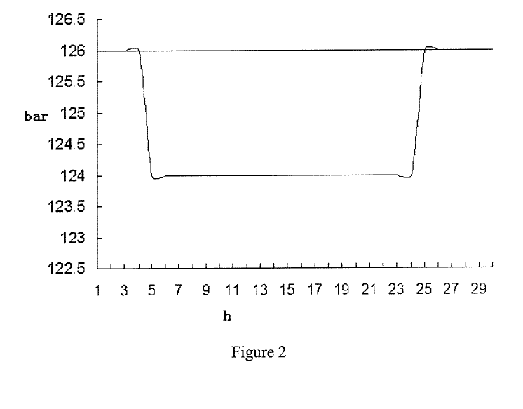

As set out in FIG. 2, hydrogen adsorption under an electric field at room temperature is displayed. The adsorbent is Carbon Black, BP200 (1400 m²/kg). The vertical line at 126 bar is the hydrogen adsorption at room temperature, without an electrical field. The other line is the when the electrical field was introduced.

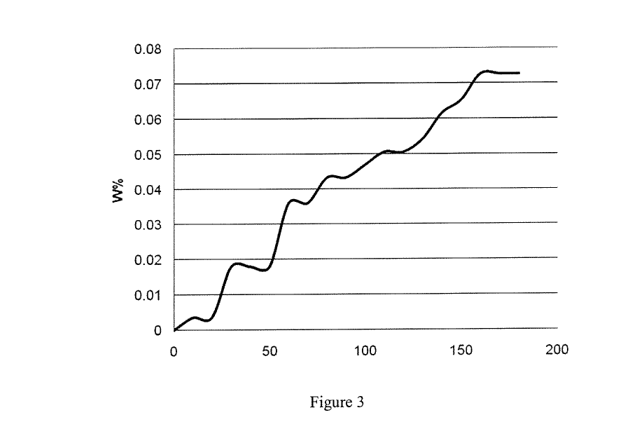

FIG. 3 shows hydrogen adsorption under an electric field at room temperature, with 0.9945 g of carbon BP2000. BY employing the Ideal Gas equation, (PV/T=C), a result of 7.05 wt % is calculated.

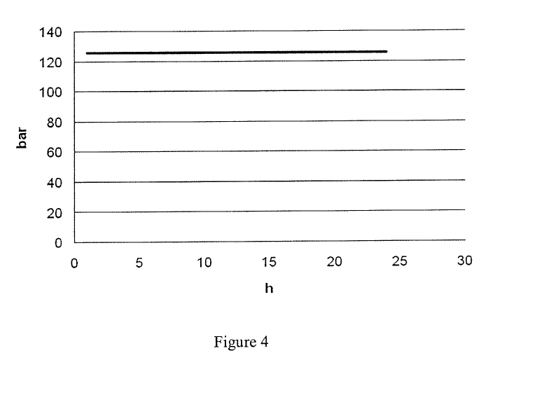

FIG. 4 illustrates the results of using 0.5506 g carbon nanotubes, and where an electrical field has been employed.

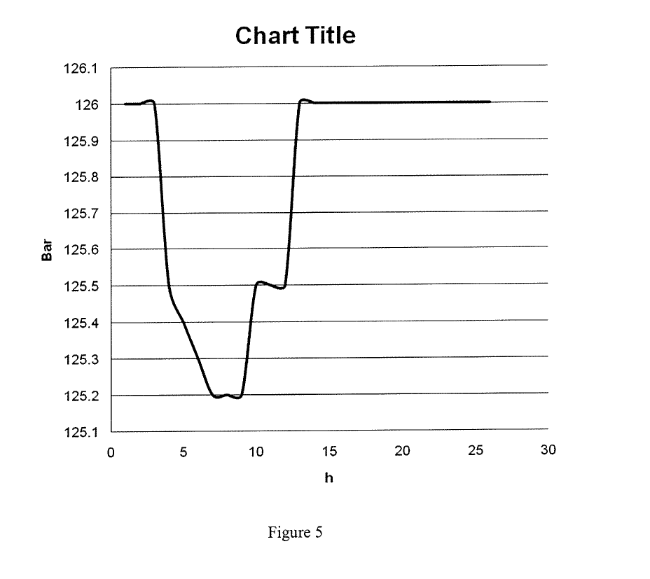

For FIG. 5, 1.0002 g functionalized carbon (XC72-SO₃H)has been used, and the electric field has been introduced. 1.76 wt % hydrogen storage has been obtained.

Using BP2000 carbon black, under 10 KV voltage, and electric field of 10e+7 V/m. at room temperature (298 K), 7.05 wt % (mass of hydrogen/mass of sorbent) hydrogen adsorption has been reached. Using BP200 carbon black under 10 KV voltage, and 10e+7 V/m at 77 K temperature, 8.04 wt % (mass of hydrogen/mass of sorbent) hydrogen adsorption has been reached.

I claim:

1. A method for enhancing adsorbability of molecules on a suitable adsorbent comprising subjecting said molecules to an electric/magnetic field sufficient to increase said molecules' dipole, and consequently the bonding energy, in the presence of said suitable adsorbent.

2. The method of claim 1 wherein said molecules are essentially non-polar, and are hydrogen or hydrogen containing molecules.

3. The method of claim 2 wherein said molecule is a C₁-C₆ alkane.

4. The method of claim 1 wherein said adsorbent is a high surface area absorbent having either a positive or negative charge.

5. The method of claim 1 wherein said electric/magnetic field is at least 3.4304e4 statV/cm.

6. The method of claim 1 wherein said molecules are at least partially in the gaseous state.

7. A method for storing, and optionally releasing, molecules on a suitable adsorbent comprising subjecting said molecules to an electric/magnetic field sufficient to increase said molecules' dipole, consequently the bonding energy, in the presence of said suitable adsorbent.

8. The method of claim 7 wherein said molecules are essentially non-polar, and are hydrogen or hydrogen containing molecules.

9. The method of claim 8 wherein said molecule is a C₁-C₆ alkane.

10. The method of claim 7 wherein said adsorbent is a high surface area absorbent having either a positive or negative charge.

11. The method of claim 7 wherein said electric/magnetic field is at least 3.4304e4 statV/cm.

12. The method of claim 7 wherein said molecules are at least partially in the gaseous state.

13. The method of claim 7 wherein said adsorbent is charged, and said charge is controlled by using potential.

14. The method of claim 7 wherein said stored molecules are released.

15. The method of claim 14 wherein said adsorbent is a high surface area absorbent having either a positive or negative charge, and said release is carried out by reducing the charge.

16. The method of claim 7 wherein said molecules are at least partially in the gaseous state.

17. A molecule storage unit comprising a chamber for housing molecules and an electric/magnetic field for increasing said molecules' dipole and consequently the bonding energy, and a suitable adsorbent which is in the chamber or fluidly connected thereto.

18. The storage unit of claim 17 wherein said molecules are essentially non-polar and are hydrogen or hydrogen containing molecules.

19. The storage unit of claim 17 wherein said molecules are C₁-C₆ alkane.

20. The storage unit of claim 17 wherein said adsorbent is a high surface area absorbent having either a positive or negative charge.

21. The storage unit of claim 17 wherein said adsorbent has at least about 0.08 kg hydrogen/kg adsorbed thereon.

22. The storage unit of claim 17 wherein said molecules are at least partially in the gaseous state.

23. The storage unit of claim 17 having means for adjusting the surface potential of said adsorbent.
